(19) United States
(12) Patent Application Publication
(10) Pub. No.: US 2010/0314795 A1
(43) Pub. Date: Dec. 16, 2010

(54) METHOD FOR THE PRODUCTION OF SWITCH TIES, AND SWITCH TIES PRODUCED ACCORDING TO SAID METHOD

(75) Inventors: Wolfgang Reinig, Weinboehla (DE); Gundolf Spitzner, Allersberg (DE); Stephan Freudenstein, Neumarkt (DE)

Correspondence Address: LUCAS & MERCANTI, LLP, 475 PARK AVENUE SOUTH, 15TH FLOOR, NEW YORK, NY, 10016, US

(73) Assignee: RAIL.ONE GMBH, Neumarkt (DE)

(21) Appl. No.: 12/523,922

(22) PCT Filed: Jan. 9, 2008
(86) PCT No.: PCT/DE2008/000025

§ 371 Date: Dec. 21, 2009

(30) Foreign Application Priority Data
Jan. 22, 2007 (DE) 10 2007 004 038.7

(51) Int. Cl. B29C 39/10

(52) U.S. Cl. 264/228

(57) ABSTRACT

Disclosed is a method for continuously producing switch ties which differ from one another with respect to the length thereof and the mounting position of rail fastenings. Said method comprises the following steps: one or more supporting metal sheets and/or one or more internal molds are mounted in a tie mold according to the length and the shape of the switch tie to be produced, or at lease one tie mold is used which is adapted to the geometry of the switch tie to be produced; bracing bars are inserted as a reinforcement; the bracing bars are simultaneously tightened in an automatic manner by means of pairs of spindles, each bracing bar being individually tightened; concrete is filled into the tie mold; the switch tie is allowed to set; the switch tie is removed from the mold.

The invention relates to a method of manufacturing points sleepers.

Points are track structures which allow rail vehicles to transfer from one track to another without interrupting travel. The points rest on special points sleepers, which are longer than normal sleepers and are currently preferably manufactured from pre-stressed concrete. A set of points with a typical length of 30 to 150 metres and a typical gap between the points sleepers of 0.6 m requires a larger number of different points sleepers, which differ in their length and fixing position for rail fixings. The structure of a set of points and the manufacture of the necessary points sleepers is thus substantially more complicated and expensive than for a normal rail carriageway.

Points sleepers have hitherto been manufactured in what is known as a long pre-stressing bed. For this method, a large number of base plates of different lengths are required, which are disposed consecutively in the longitudinal direction. The long pre-stressing bed may be 100 or 150 metres long in all, and thus this method takes up a lot of space. As a reinforcement, usually plural pre-stressing rods are used, which are drawn through the pre-stressing bed and are stressed. After the concrete cast into the moulds has hardened, optionally by applying heat, the pre-stressing rods are sawn apart between the moulds, so that individual pre-stressed points sleepers are formed. This method of manufacture is comparatively slow and inflexible.

The object of the invention is to indicate a method of manufacturing points sleepers which can be carried out more simply and more flexibly.

To achieve this, a method is provided for manufacturing points sleepers which have different lengths and fixing positions for rail fixings, using the rotation method, comprising the following steps: fixing of one or more depositing plates and/or one or more mould inlays in a sleeper mould, according to the length and shape of the points sleeper to be manufactured or the use of at least one sleeper mould adapted to the geometry of the points sleeper to be manufactured; insertion of pre-stressing rods as reinforcement; automatic simultaneous pre-stressing of the pre-stressing rods with spindle pairs, each pre-stressing rod being stressed individually; filling the sleeper mould with concrete; leaving the points sleeper to harden; removal of the points sleeper from the mould.

The invention is based on the knowledge that the manufacture of points sleepers is possible by adapting the sleeper moulds by depositing plates or mould inlays to the different lengths and to the different fixing positions of the rail fixings of individual points sleepers. A sleeper mould may be manufactured either to fit the respective points sleeper or be adapted to the geometry of the points sleeper by mould inlays or be adapted to different lengths of points sleepers by depositing plates.

In the extreme case, only a single points sleeper of a specified size is required. To manufacture in this case, the sleeper moulds are arranged to fit by means of the depositing plates and/or mould inlays. In the first place, the depositing plates or the mould inlays fix the lateral ends and hence the length of a points sleeper, and furthermore the fixing position of rails fixings can be adapted by corresponding depositing plates or other inserts in the sleeper mould.

In this method of manufacturing points sleepers, the manufacture takes place by direct adhesion, whereby after insertion and pre-stressing of the pre-stressing rods as reinforcement, the concrete is poured into the sleeper mould. After leaving to harden and removal of the points sleeper from the mould, a pre-stressed points sleeper is obtained, whose manufacture is concluded by the assembly of rail fixings. In this method also, adaptation to different sleeper lengths is effected by depositing plates and/or mould inlays inserted into the sleeper mould.

According to a further embodiment of the method according to the invention, it is proposed that the pre-stressing rods are held individually at one end each by means of a tie bolt and at the opposite end by means of a tensioning device, the tie bolt and tensioning device being supported on the or one depositing plate and/or mould inlay and/or end face of the sleeper mould.

In order to increase the efficiency of the method according to the invention, a sleeper mould can be used in which two, three, four or more points sleepers disposed adjacent to one another are manufactured. In such a sleeper mould, either a depositing plate can be used, which is disposed transverse to the sleepers and thus defines the length of all the sleepers in the sleeper mould, or alternatively four separate depositing plates can be used in a sleeper mould containing for example four points sleepers, so that four different points sleepers can be manufactured at the same time. It is possible to insert or incorporate plural, e.g. four different mould inlays in one sleeper mould or the mould can be adapted to plural, e.g. four, different geometries.

In the method according to the invention, it is particularly preferred if one points sleeper is provided with four pre-stressing rods. The four pre-stressing rods can be stressed in an automated manner, the pre-stressing operation taking place simultaneously and individually for all pre-stressing rods.

In addition, the invention relates to a points sleeper manufactured according to one of the methods disclosed. This points sleeper differs in its structure from known points sleepers, which are manufactured conventionally in the long pre-stressing bed.

Further advantages and details of the invention will be described with the aid of embodiments and with reference to the drawings, which are schematic diagrams and show:

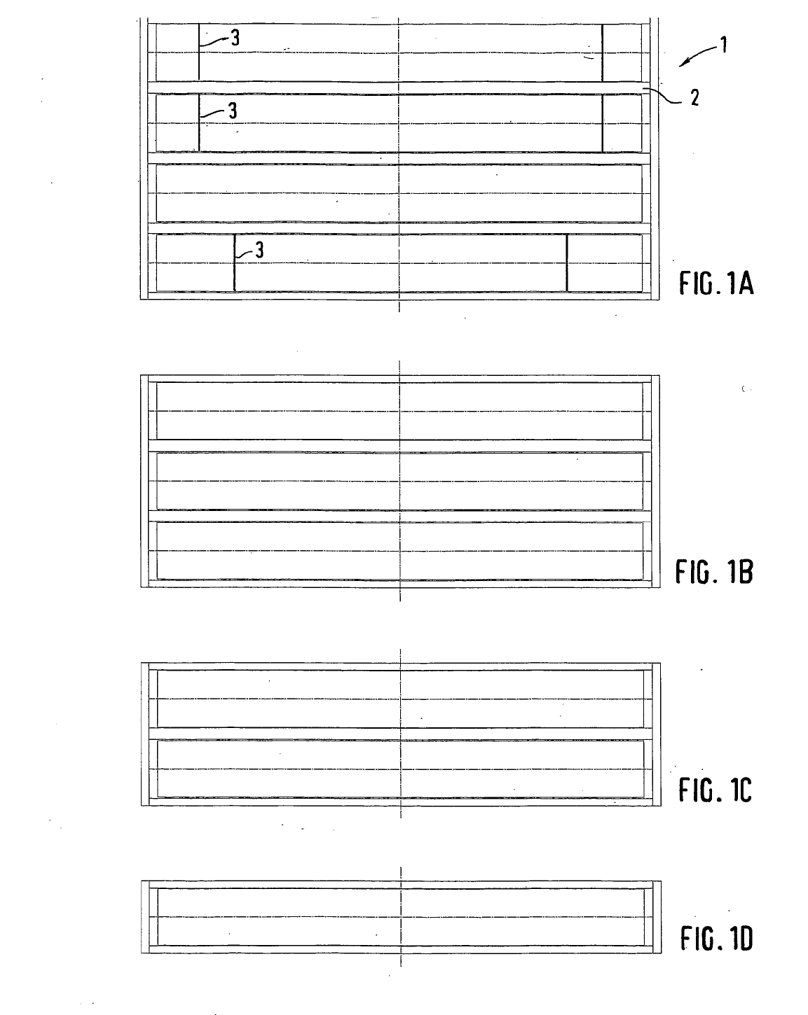

FIG. 1A to 1D, sleeper moulds which are used in the methods according to the invention;

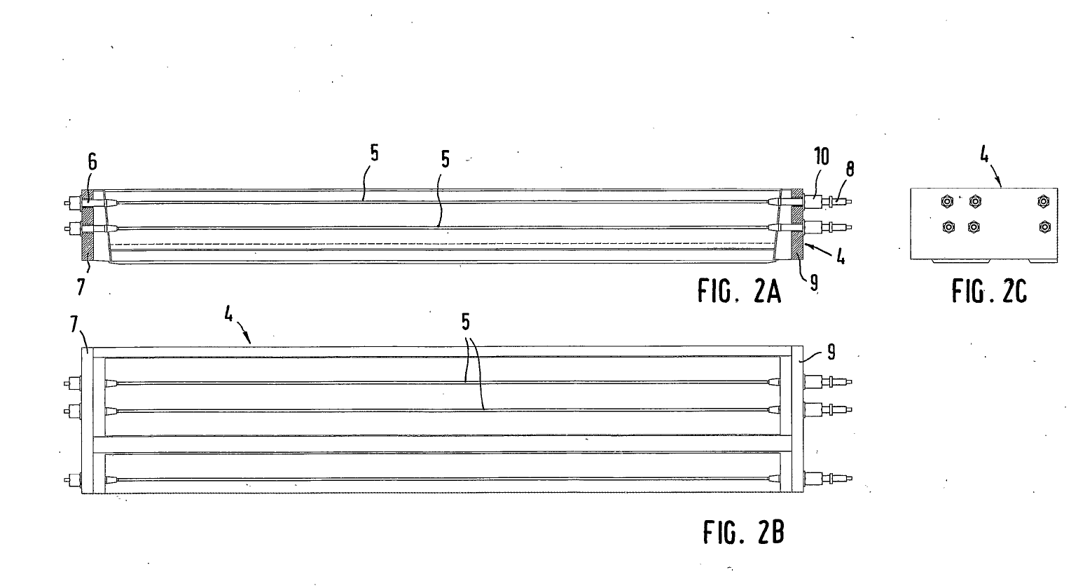

FIG. 2A to 2C, various views of a sleeper mould with pre-stressing rods inserted; and

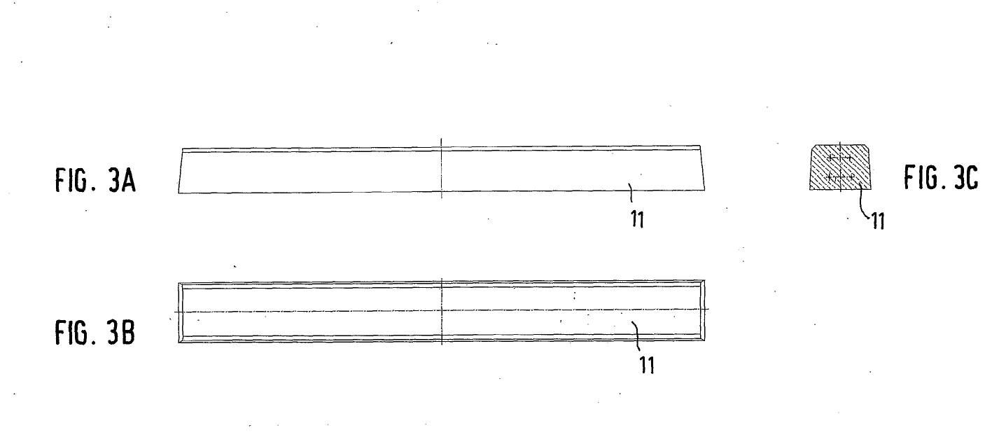

FIG. 3A to 3C, various views of a points sleeper according to the invention.

FIG. 1A shows a first sleeper mould which can be used in the method according to the invention. The sleeper mould 1 is formed as a compound mould, in which four points sleepers can be manufactured at the same time. The sleeper mould is a box open at the top and is divided by separating walls 2 into four compartments, in each of which one points sleeper can be manufactured. Depositing plates 3 can be inserted into the sleeper mould 1 in order to vary the interior of the sleeper mould 1, in particular the length of a points sleeper to be manufactured can be varied thereby. The depositing plates 3 can be fixed in various ways in the sleeper mould 1, e.g. via a screw fixing, a plug-in connection or by sliding into a groove on the side of the mould. In addition, the fixing can be effected by welding or a magnetic mounting or the like.

In the sleeper mould 1, corresponding fixing devices are provided so that the depositing plates 3 can be flexibly positioned and removed again simply and can be inserted at a different place. In other embodiments, it can be provided that the depositing plates are fixable infinitely variably in the sleeper mould, so that any desired length of a points sleeper can be manufactured. As can be seen from FIG. 1, the depositing plates for plural points sleepers can be positioned at the same place in the sleeper mould 1, or alternatively each of the four points sleepers being manufactured in the sleeper mould 1 shown in FIG. 1 can have a different length. In addition to the depositing plates, in the mould devices or inserts for rail fixings can be mounted, whose position varies with the length of the points sleeper. These fixings can likewise be positioned flexibly at different places in the sleeper mould 1. This is particularly advantageous if a large number of points sleepers are to be manufactured, which differ only slightly in their length and position of the rail fixings. Mould inlays which define different geometries can be inserted into the sleeper mould formed as a frame structure, which generates the necessary rigidity, so that points sleepers with different shapes can be manufactured.

FIGS. 1B, 1C and 1D show further sleeper moulds in which simultaneously three, two or only one single points sleeper can be manufactured.

FIGS. 2A, 2B and 2C show details of a sleeper mould in various views. FIG. 2A is a side view in section of a sleeper mould 4. FIG. 2B shows the associated plan view. FIG. 2C shows a front elevation of the sleeper mould.

Pre-stressing rods 5 are inserted into the sleeper mould 4 to act as the reinforcement for the points sleeper. As can be seen from FIG. 2C, four pre-stressing rods 5 are used per points sleeper.

On one side of the sleeper mould 4, the pre-stressing rods 5 are held by tie bolts 6, which bear on the side wall 7 of the sleeper mould 4. At the opposite end of the sleeper mould 4, the pre-stressing rods 5 are fixed with pre-stressing bolts 8, which are supported on the side wall 9 of the sleeper mould 4. Before the concrete is poured in, the pre-stressing rods 5 are pre-stressed by a nut 10 according to the statistical requirements of the points sleeper. Optionally, depositing plates are inserted into the sleeper mould 4, which are not shown however in FIGS. 2A to 2C for the sake of clarity. In addition, further inserts for the sleeper mould 4 can be provided in order to produce a special profiling of the points sleeper or to produce fixing points for rail fixings.

After casting of the concrete, this is shaken and thus compressed. The hardening of the concrete takes place of its own accord, but this process can be accelerated by applying heat, possibly in a heat chamber. After hardening of the points sleeper, the screw-tightening of the pre-stressing bolts 8 and of the tie bolts 6 with the respective pre-stressing rod 5 is released and the points sleeper can be removed from the mould. Next, the rail fixings are mounted.

A points sleeper 11 manufactured by this method is shown in FIGS. 3A to 3C in various views.

1. Method of manufacturing switch ties in the rotation method, which differ in their length and fixing position of rail fixings, comprising the following steps:
fixing of one or more depositing plates and/or of one or more mold inlays in a switch rail road tie mold according to the length and shape of the switch tie to be manufactured;
insertion of pre-stressing rods as a reinforcement;
automatic simultaneous pre-stressing of the pre-stressing rods with spindle pairs, each pre-stressing rod being pre-stressed individually;
filling of the mold with concrete;
leaving the switch tie to harden;
removal of the switch tie from the mold.

2. Method according to claim 1, wherein the pre-stressing rods are held at one end by means of a tie bolt and at the opposite end by means of a tensioning device, the tie bolt and the tensioning device being supported on the one or more depositing plate and/or on the mold inlay and/or on an end face of the mold.

3. Method according to claim 1, wherein two, three or four switch ties are manufactured disposed adjacent to one another in the mold.

4. Method according to claim 1, wherein the switch tie has four pre-stressing rods.

5. Method according to claim 2, wherein different lengths of tie bolt and pre-stressing spindles are used to manufacture the switch tie.

6. Method according to claim 1, wherein the pre-stressing rods are pre-stressed simultaneously and individually.

7. (canceled)
